(19) United States
(12) Patent Application Publication
(10) Pub. No.: US 2014/0032433 A1
(43) Pub. Date: Jan. 30, 2014

(54) METHOD AND SYSTEM FOR MONITORING PROPERTY

(71) Applicant: MonitorMyProperty LLC, (US)

(72) Inventors: Stephen G. Eick, Naperville, IL (US); Bradley G. Hays, Warrenville, IL (US)

(73) Assignee: MONITORMYPROPERTY LLC, Warrenville, IL (US)

(21) Appl. No.: 13/768,657

(22) Filed: Feb. 15, 2013

Related U.S. Application Data
(60) Provisional application No. 61/599,172, filed on Feb. 15, 2012.

(51) Int. Cl. G06Q 50/16; G06Q 10/10

(52) U.S. Cl. CPC G06Q 50/163; G06Q 10/10
USPC 705/314

(57) ABSTRACT

A business method and system for managing property is disclosed. A database of property profiles is created an accessed using an web-based interface from a computing device such as a laptop, smart phone or tablet. An integrated interface is provided for managing a large number of tasks required to manage a property, including monitoring the property, setting up inspections and work orders, and collecting images, videos and pricing estimates. A business method and system for monitoring vacant property is also disclosed. Sensors, video cameras and other monitoring devices can be installed in a vacant property and used to monitor the property for various kinds of damage. The same integrated interface is used to receiver information from the sensors and other devices.

### RELATED APPLICATION

This application claims the priority benefit of U.S. Provisional Patent Application No. 61/599,172, filed Feb. 15, 2012, which is incorporated herein by reference in its entirety.

### BACKGROUND

The invention relates generally to information communication systems and more particularly to interactive systems for monitoring user property.

The severity of the recent financial crisis has had an enormous impact on the real estate industry. As a result of this impact there has been tremendous growth in the number of foreclosed, for sale, and vacant properties. In fact, a government census released at the end of 2011 placed the number of vacant homes in the U.S. at 18.5 million. When commercial and retail properties are added to that staggering number, there are literally millions of vacant properties owned by banks and other investors. While sitting vacant, these properties are particularly vulnerable to many costly and potentially dangerous issues. Floods, mold, break-ins, squatters, leaking gas, theft of materials and various forms of vandalism all add significant cost to the maintenance of the property while eroding the value.

Prior art systems for monitoring vacant property require regular in-person visits. This is time consuming and can be dangerous, depending on the neighborhood of the vacant property. As a result, properties are visited infrequently, or not at all, and become even more prone to damage and other problems.

Thus, a need exists for a remote property monitoring solution that is low cost and quick to install and provides regular monitoring without the need for in-person visits.

### SUMMARY

The invention in one implementation encompasses an apparatus and method for monitoring property so as to significantly reduce or eliminate the cost of property disasters by quickly alerting property owners and managers. All of the components required for property management are integrated into a single system with a easy-to-use platform.

In one embodiment the invention comprises a business method for managing property including the steps of creating a database of information about one or more properties to be managed, said database operatively coupled to a server and both said server and said database operatively coupled to at least one network; using a web-based interface to said server to access property information in said database over a network; and using the web-based interface to said server to perform property management tasks. In a further embodiment, the property to be managed is real estate property.

In a further embodiment, the invention comprises a business method for monitoring vacant property comprising the steps of creating a database of information concerning one or more properties to be managed, said database operatively coupled to a server and both said server and said database operatively coupled to at least one network; using a web-based interface to access said server, over said network, to access a plurality of property information in said database and to perform property management tasks; using the web-based interface to access said server to perform property management tasks; installing one or more sensors in the one or more properties for monitoring the properties; receiving, by the server, real-time information from the one or more sensors and generating incident reports and alerts to persons responsible for the properties when one or more sensors detect a condition outside of defined norms.

In any of the above further embodiment, the business method includes a step of reporting incidents at the property including at least one of vandalism, theft or natural disasters.

In any of the above embodiments, the business method includes the steps of installing one or more sensors at the property and receiving an alarm when one or more of the sensors detects a condition outside of standard norms.

In any of the above embodiments, the business method includes the steps of selecting a property requiring inspection, selecting a inspector to perform the inspection, using the web-based interface to send a request to the inspector with information about the property to be inspected and the type of inspection required and using the web-based interface to generate a list of open and closed inspections.

In any of the above embodiments, the business method includes the steps of selecting a property requiring repair or other work, selecting a vendor to perform the repair or other work, using the web-based interface to send a work order to the vendor with information about the property to be inspected and the type of repair or work required and using the web-based interface to generate a list of open and closed work orders.

In any of the above embodiments, the business method includes the steps of using the web-based interface to access and update a list of vendors approved to perform inspections and repair or other work on properties being managed.

In any of the above embodiments, the business method includes the steps of entering a global positioning system (GPS) identifier for one or more assets associated with the properties, receiving real-time information about the GPS coordinates of the one or more assets over the one or more networks and storing the information in the database, graphically displaying the position of the asset on a map in real-time and accessing additional information about the asset using the web-based interface.

In any of the above embodiments, the business method includes the steps of viewing real-time video feeds from cameras installed at the property and uploading and viewing images of the property.

In any of the above embodiments, the business method includes the steps of selecting a property requiring an appraisal or broker price opinion (BPO), selecting a vendor to perform the appraisal or BPO, using the web-based interface to send a request to the vendor with information about the property needing an appraisal or BPO and using the web-based interface to generate a list of open and closed appraisals and BPOs.

In a further embodiment, the invention comprises a system for remotely monitoring property including a web server operatively coupled to one or more networks, a database for storing information about one or more properties being monitored, said database operatively coupled to the server and the one or more networks, a computing device for using a web-based interface to access the web server and update the database over the one or more networks, one or more sensors installed in a property to be monitored and operatively coupled to the network, said one or more sensors sending real-time alerts to said web server when the one or more sensors detects a condition outside standard norms.

In any of the above embodiments, the business method wherein the web-based interface is accessed using a computing device, for example, a smart phone, a laptop, a desktop computer or a tablet.

### DESCRIPTION OF THE DRAWINGS

Features of example implementations of the invention will become apparent from the description, the claims, and the accompanying drawings in which:

FIG. 1 is depicts one implementation of a system architecture for remotely monitoring property.

FIG. 2 is a more detailed representation of the dashboard and backend architecture of the system shown in FIG. 1.

FIG. 3 is a representation of the Portfolio Tab of the apparatus of FIG. 1 and enables an investor to see all of the buildings in his or her portfolio using either a list or thumbnails view.

FIG. 4 is a representation of the Profile Tab of the apparatus of FIG. 1 that enables a property manager to see the profile of a building which includes all relevant information about the building.

FIGS. 5A and 5B are a representation of the Incident Tab of the apparatus of FIG. 1 that enables a property manager to see a listing of all past property management incidents at a building.

FIG. 6 is a representation of the Incident Tab of the apparatus of FIG. 1 with the Report New Incident popup dialog expanded that enables a property manager to enter in a new incident.

FIG. 7 is a representation of the Alerts Tab of the apparatus of FIG. 1 which enables a property manager to see the status of the alarm system in a building

FIG. 8 is a representation of the Weather Tab of the apparatus of FIG. 1 which enables an investor to see the weather status at a building in his portfolio.

FIG. 9 is a representation of the Inspection Tab of the apparatus of FIG. 1 which enables a property manager or investor to schedule an inspection at a building and to view the results of past inspections.

FIG. 10 is a representation of the Inspection Tab of the apparatus of FIG. 1 with the “request inspection” popup dialog exposed.

FIG. 11 is a representation of the Vendors Tab of the apparatus of FIG. 1 which enables a property manager or investor to manage the vendors which perform services on the building.

FIG. 12 is a representation of the Tracking Tab of the apparatus of FIG. 1 which enables a property manager to view the locations of tracked assets in the building.

FIG. 13 is a representation of the Activity Tab of the apparatus of FIG. 1 which is a historical log of all the management activities that occurred at the property.

FIG. 14 is a flowchart of the operation of the system by a user receiving an alarm.

FIG. 15 is a flowchart of the operation of the system by a user logging in before performing an inspection. FIG. 15B is a flowchart of the operation of the system by a user while performing an inspection.

### DETAILED DESCRIPTION

In one embodiment, the invention provides a low cost turnkey solution through the use of a real-time wireless monitoring and alerting system and a real-time web dashboard. The system significantly reduces or eliminates the cost of property disasters by quickly alerting property owners and managers thereby enabling them to address issues of floods, mold, break-ins, squatters, theft and vandalism as they arise. In addition, the MMP system reduces property management costs for investors and property managers. The system allows for fully integrated property management resources and tools including, security alarms, real-time video, inspection reports, incident management, work order submissions, property cost accounting and broker price opinion reports. Operational costs savings are provided by using the live video to remotely access real time property data and video from a computer or mobile device, thereby eliminating costly drive by inspections.

In further embodiments, the invention is suitable for many different aspects of property management. In particular, with the addition of an accounting system, the inventive system will integrate a holistic set of capabilities to provide a complete solution for property management. For a property manager integrating all relevant information into a dashboard provides significant value.

Besides monitoring vacant buildings, the inventive system is useful for a broad set of property types including, for example, monitoring oil wells, monitoring farm buildings, monitoring construction sites, etc.

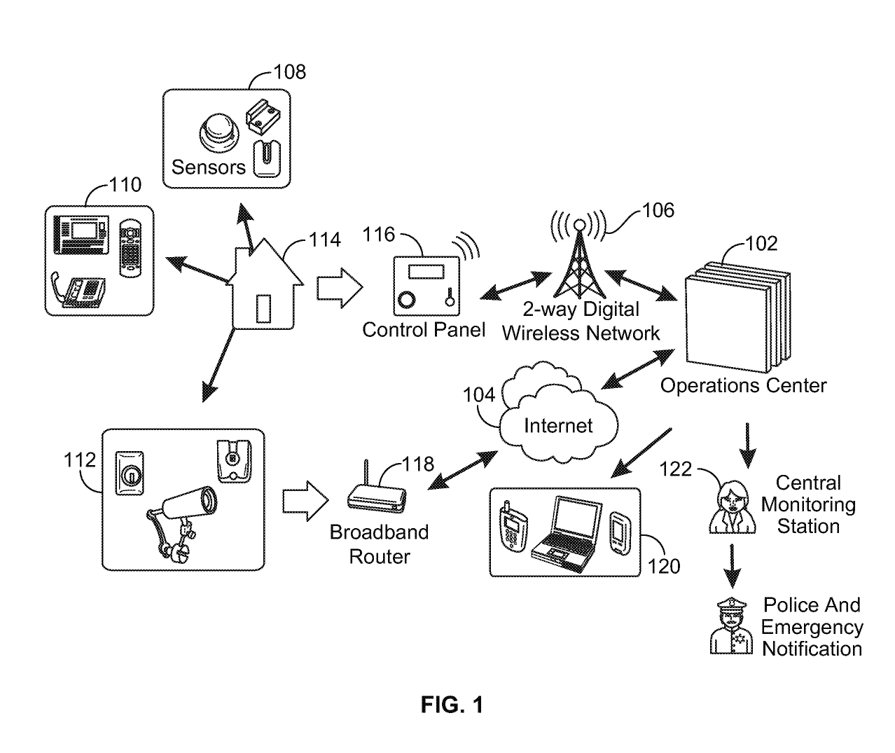

A system according to one embodiment of the invention is shown in FIG. 1. A monitoring operations center 102 is coupled to both the internet 104 and a two-way digital wireless network 106. One or more sensors 108 and monitoring devices 110 are installed together with a wi-fi network in a property 114 then wirelessly coupled to a gateway/control panel 116. Gateway 116 communicates with monitoring operations center 102 via wireless network 106. In addition, one or more video cameras 112 can be installed in property 114, and then connected to a broadband router which communicates with monitoring operations center 102 via internet 104. Sensors 108 and devices 110 provide real-time information about property 114. The sensors can include, for example, door sensors to detect if doors have been opened, temperature sensors and motion sensors.

Monitoring operations center 102 can also be connected to a variety of web-connected devices 120 including, for example, remote control devices, smart phones, laptops and other computing devices. An operator 122 accesses monitoring operations center to update the system and observe real-time alerts.

The system of FIG. 1 can be operated in properties with or without power. In the case where there is no power, sensors that are battery powered can be used for monitoring. The sensed information can be collected at appropriate time intervals ranging from continuously to every few seconds, minutes or hours, as desired. Gateway 116 is capable of handling a range of sensors. Many commercial-grade wi-fi networks have a range of 750 which means that a single monitoring system according to the invention may be installed in a wide variety of building sizes. Larger buildings can use an expanded system. In an alternative embodiment where the property does not provide power, the gateway and sensors can be powered by marine batteries that are trickle charged with solar cells installed, for example, on the roof of a property to be monitored.

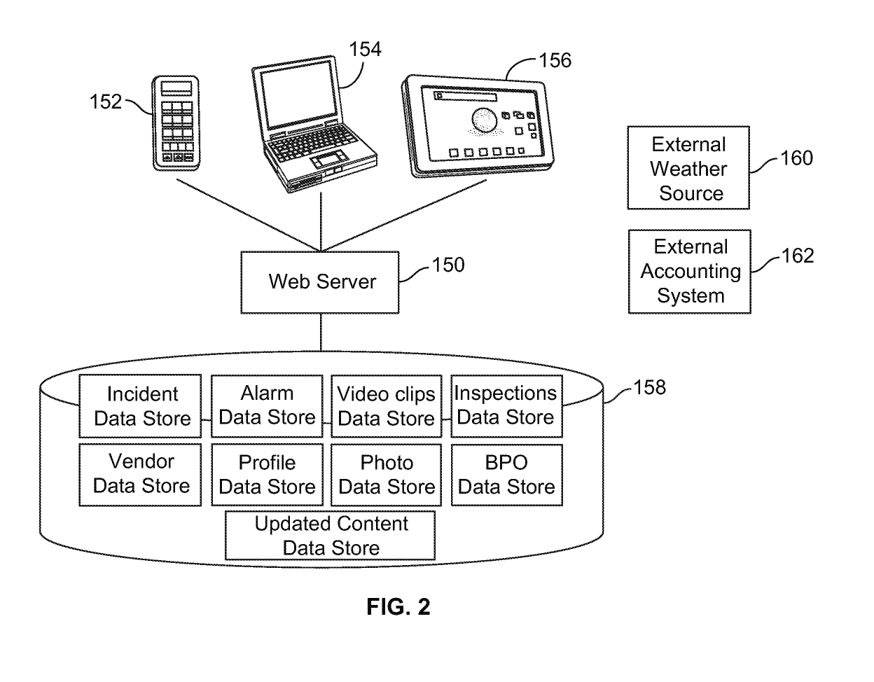

Monitoring operations center 102 is shown in more detail in FIG. 2. In an embodiment, center 102 comprises a web server 150 that is accessed by a computing device. These devices can include, for example, a smart phone 152, a laptop 154 or a tablet 156, but any suitable computing device capable of using a web-based interface may be used. Web server 150 is coupled to a database 158 that stores a wide variety of information about properties being monitored. In an embodiment, database 158 is a relational database management system (RDBMS), such as MySQL.

Database 158 stores much of the information needed by a property manager for a complete and accurate understanding of a property and its condition. For example, database 158 may include information about incident at properties, alarms, video clips and photos or properties, inspections, approved vendors and other profile and uploaded content, like addresses. Database 158 may also include pricing information used to estimate the value of a property when the expense and delay of an appraisal is not considered necessary. This information is sometimes referred to as a Broker's Price Opinion, or BPO.

Web server 150 may also be connected to an external source of weather information 160 and an external accounting system 162.

A preferred embodiment of the claimed business method is implemented as a cloud-based software dashboard and backend providing property managers and building owners a suite of fully integrated tools and resources for effective monitoring and management of vacant properties. From historical property data on financials, inspections and incident reports, work orders, expense tracking to real-time video and security, the dashboard integrates this information and provides a single source for all relevant content that includes:

Investor Building Portfolio

Building Profile/Description

Incident Management

Alarm and Home Automation (Temperature, Humidity, Moisture, . . . )

Live real-time Video

Weather

Inspections (Historical and Pending)

Work Orders

Vendor Management

GPS Tracking (worker and building assets including furnaces, air conditioners, and other building assets)

Photo/Video Gallery

Realtor BPO

Activity Log

Accounting

There is tremendous value to investors, banks, receivers, and real-estate brokers to provide this information in a single destination that is easily accessible on a broad range of devices. For example, a bank REO manager who is responsible for hundreds of buildings can easily pull up a picture of a specific building, verify the activity of vendors by looking at the outstanding work orders, check the property for damage using the live video, and access the financials and Realtor BPO when a purchase offer comes in. He can access the alarm activation and deactivation log to see how often the building is being shown which might be an indication of another forthcoming offer. When there is damage to the building, he will have ready access to the inspection reports and pictures documenting the building's condition before the damage incident for insurance claims. Providing access to all of this information in real-time will enable the bank REO manager and property manager to make better decisions with respect to vendors, city code inspectors, purchase offers and thereby save money.

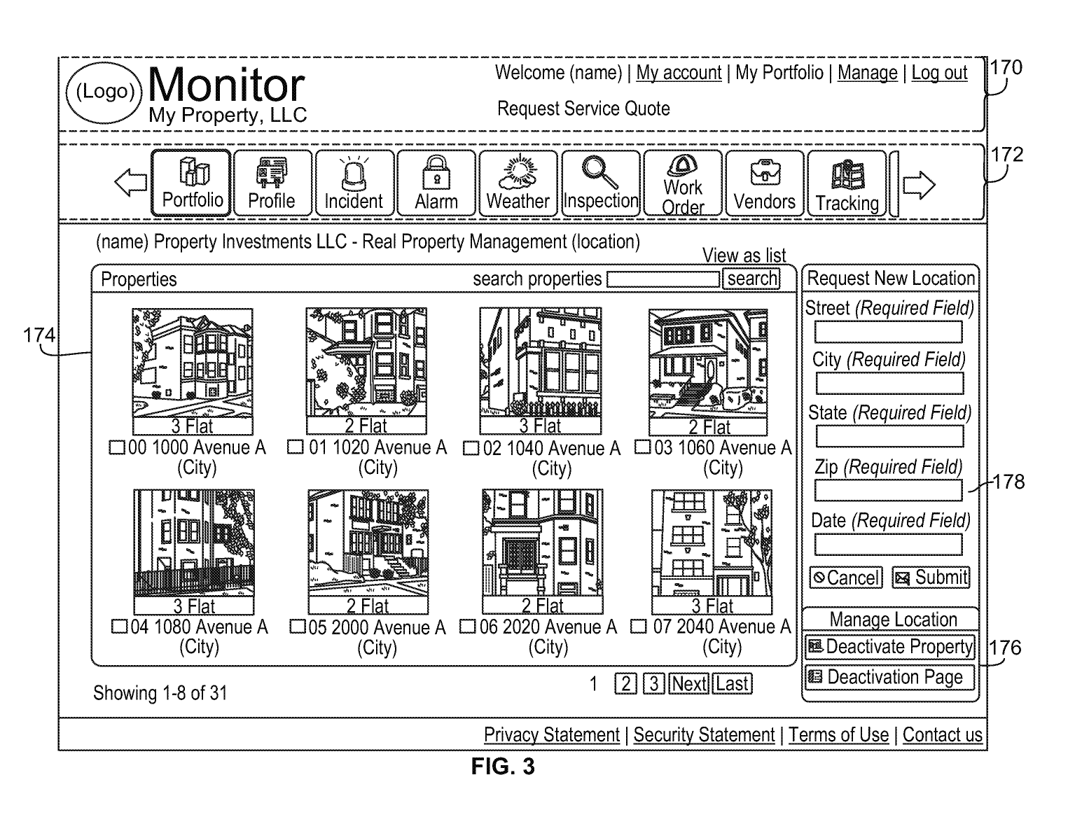

An embodiment of the dashboard is shown in FIG. 3. This is a screen shot of what would be shown in a web browser window on a user device. All of the figures that depict screen shots are intended to represent the type of information that would be presented to a user of the inventive system, but the presentation of that information is not limited to the specific layout shown. A header area 170 includes a logo and administrative links, for example “My account”, “My portfolio”, “Manage” and “Login/Logout.” Below the header is a main navigation menu 172 which includes a number of tabs that allow a user to access different areas of the dashboard. In a preferred embodiment, there are 12 tabs but any suitable number may be used to provide the required functionality.

When the “Portfolio” tab of menu 172 is selected, several panes of content are shown below menu 172. Pane 172 contains a list of properties being managed. As shown, the properties are represented by images but this pane could also contain a list view. Pane 176 allows a user to manage a selected property by deactivating the listing or going to a deactivation page for more options. Pane 178 allows a user to enter a new property into the system by sending a request to a dealer. Individual clients who own portfolios of buildings are served by property management system dealers. The dealers provide equipment, installation services, etc. When a client requests management service at new location the request email is automatically sent to the dealer who handles that client's particular account.

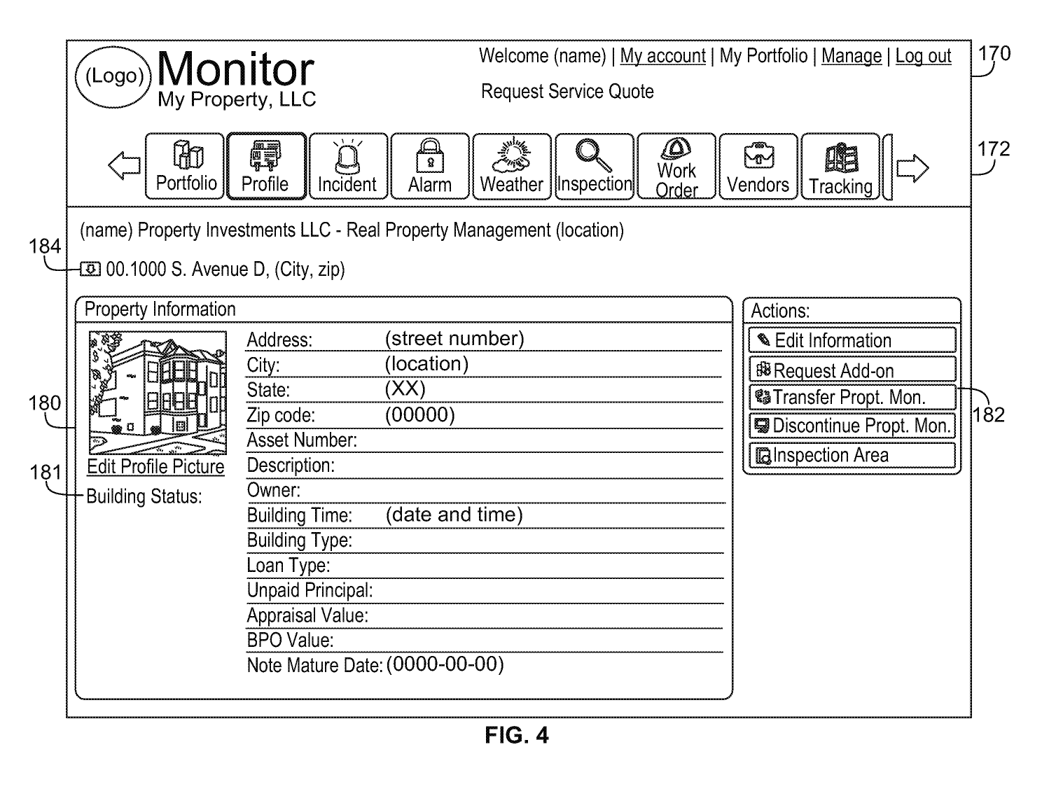

Selecting the “Profile” tab of menu 172 displays the screen shown in FIG. 4. The header 170 and menu 172 areas are the same as those shown in FIG. 3. The Profile page of FIG. 4 shows the profile of a specific building. Pane 180 contains precise details defining a property including, for example, one or more photographs, address, asset number, owner, date the property was built, type of property, loan type and unpaid principal, appraisal value, BPO value and the mature date of a note on the property. Not all of these fields are required to contain information and other fields may be provided as needed. Pane 180 also contains an indication 181 of the current status of a property.

Pane 182 of FIG. 4 is an Actions pane which provides various options to a user of the system, including editing the information displayed about a property, requesting an add-on, transferring or discontinuing property monitoring and selecting an inspection area. Requesting an add-on includes, for example, functions such as adding an alarm, adding video, adding tracking or adding Internet. Button 184 represents a location a user can select to switch to a new property.

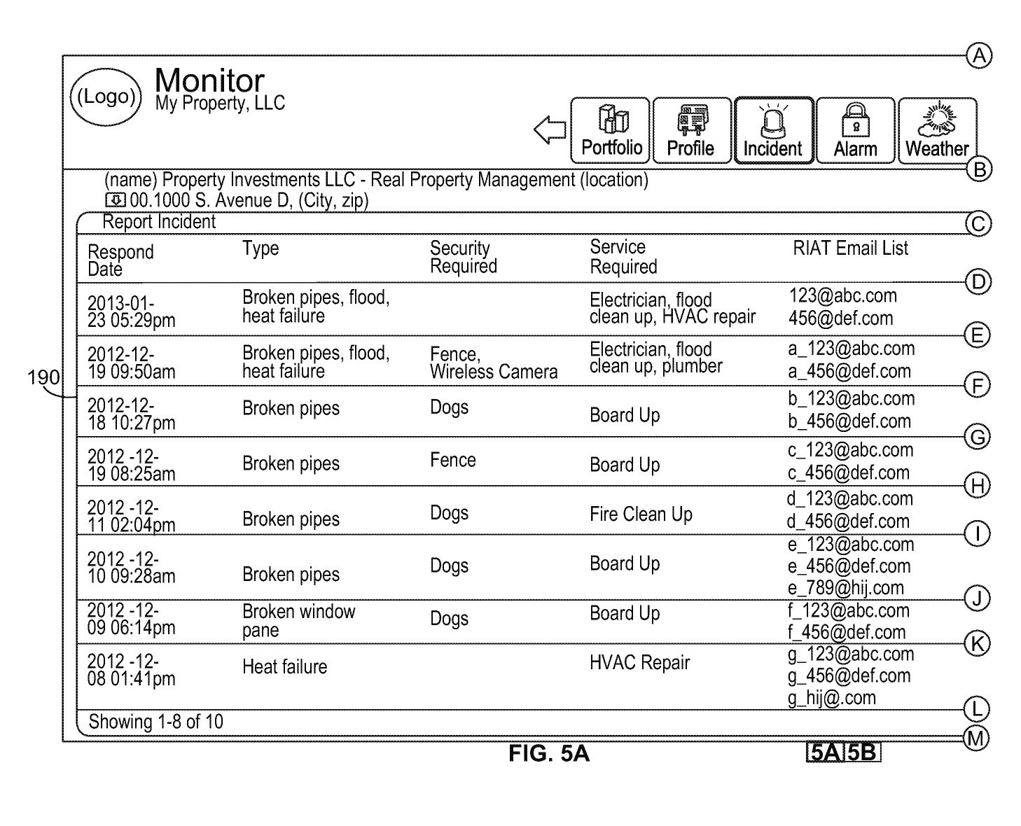

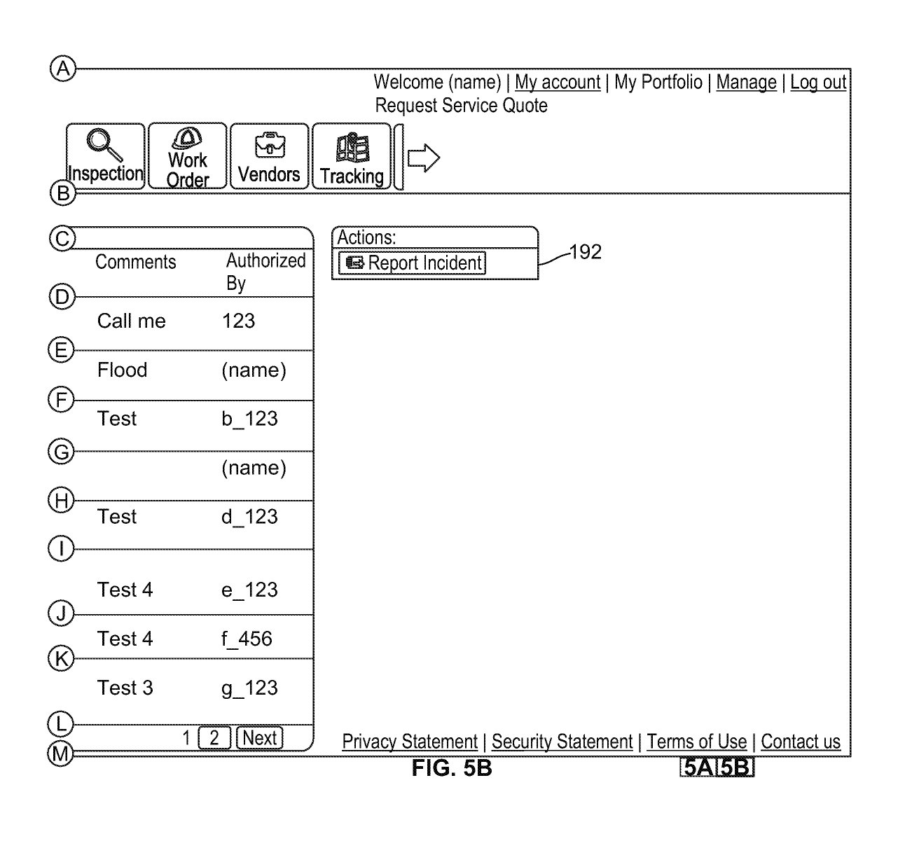

Selecting the “Incident” tab of menu 172 results in the screen shown in FIG. 5. The header 170 and menu 172 areas are the same as those shown in FIG. 3. This page is selected when an incident, for example, flooding in the basement, theft of copper, break-in, damage to the windows, has occurred at a property. As shown in FIGS. 5A and 5B, this screen allows a user to document the incident, contact emergency response team members (RIAT—Re-Entry Initial Assessment Team), and provide helpful response information.

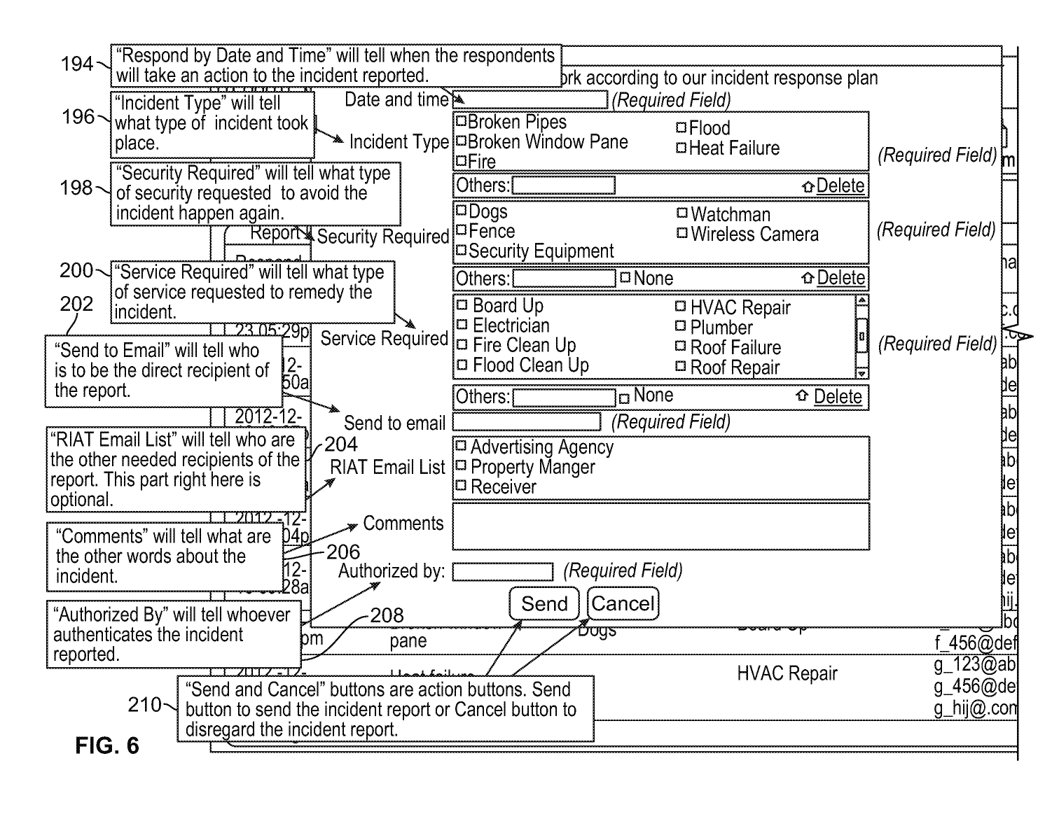

Pane 190 of FIGS. 5A and 5B shows a list of incidents at properties being monitored. Each incident may include information such as the date and type of the incident, security features at the property, service required to handle the incident and contact information for employees who will investigate/correct the incident. Areas for comments and authorization may also be provided, as well as other information as needed. Pane 192 of FIG. 5B is an Actions pane that allows users to report incidents. Selecting this button will, for example, cause the display of a pop-up form as shown in FIG. 6.

FIG. 6 shows a pop-up form for reporting incidents that includes a number of fields. Field 194 allows entry of a due date for responding to an incident. Field 196 identifies the type of incident while field 198 identifies additional security measures that should be installed to prevent a repeat of the incident. Field 200 identifies the type of service required, for example, boarding up the building, electrician or plumber servicing, flood or fire clean-up and HVAC, roof or road repair. Field 202 allows entry of an email of the person who should receive the report, while field 204 allows entry of one or more additional recipients of the report email, for example, an advertising agency, property manager or receiver. A comments area is included at 206, an authorization field is at 208 and send and cancel buttons are provided at 210.

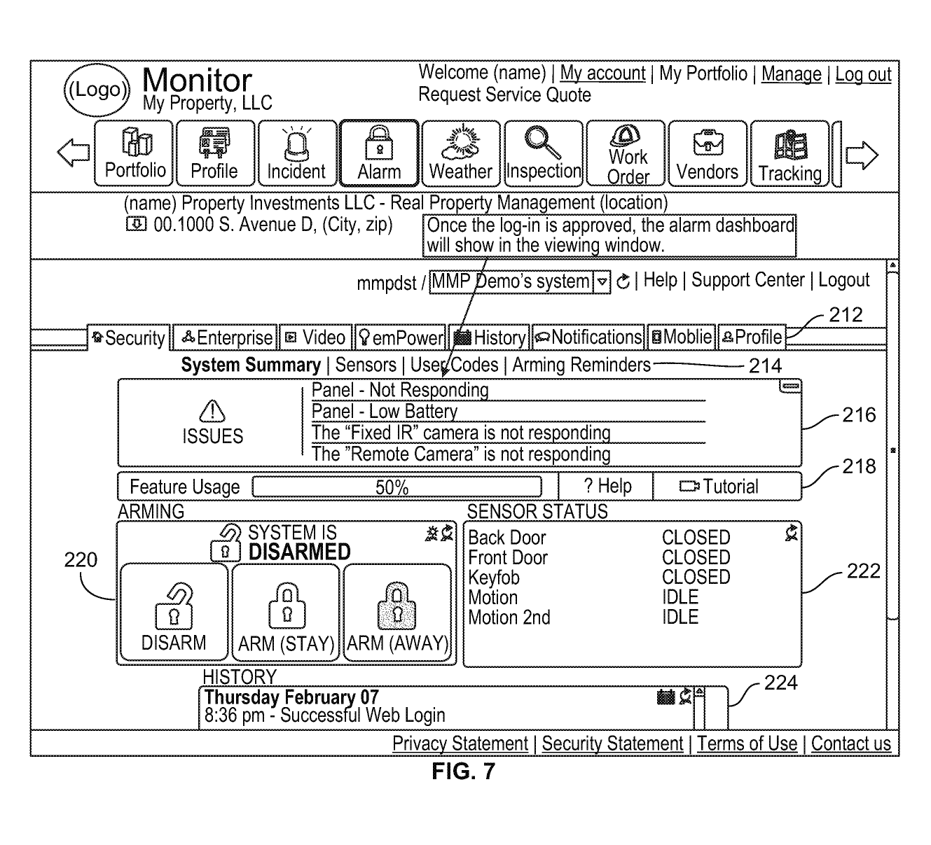

Selecting the “Alarm” tab of menu 172 results in the screen shown in FIG. 7. The header 170 and menu 172 areas are the same as those shown in FIG. 3. The Alarm and Video tools of FIG. 7 provide real-time alerting and security for the physical protection of the property. In a preferred embodiment, the monitoring system operates through a series of wireless sensors and cameras installed in housing units and connected to an area gateway. The gateway communicates wirelessly via the wireless cell phone network with the backend that records sensor triggers into a database, uses the rules engine to provide real time alerts, and provides a property management dashboard with historical and real time reports on the state of monitored properties. The system sends text and other alerts whenever any of the sensors are outside of standard norms or if any of the cameras detect motion.

The sensors used to provide alarms can include, for example, door sensors, temperature sensors and motion sensors. As shown in FIG. 7, the Alarm screen is divided into a number for panes for communicating required information. In a preferred embodiment, a login to the system is required to see alarm information. A secondary menu area is provided at 212 and can contain, for example, Security, Enterprise, Video, EmPower, History, Notification, Mobile and Profile buttons. A third menu area 214 is located immediately below the secondary menu area 212 to provide additional options for each button in the secondary menu.

The Alarm screen with the Security button selected is shown in FIG. 7. Pane 216 displays a list of all alerts that have been generated for a property that has experienced an incident. These issues can include battery low and equipment not responding types of issues, in addition to the issues identified above. Pane 218 provides a tutorial on feature usage for the alarm system. Pane 220 displays the current status of the monitoring system and allows a user to arm and disarm the system. Pane 222 displays a current status of all sensors installed in the property while pane 224 displays a history of incidents and alarms at the property. All sensor data is displayed in real-time with a selected frequency update of continuous or every few seconds, minutes or hours as desired.

Selecting the “Video” tab of secondary menu 212 provides a display of live video which includes real time streaming images from portable wireless cameras installed in the building. The live video can be used to verify intrusions when an alarm event is received, to verify vendor performance, and to check the status of the property remotely without the time and expense of a drive-by. In addition, the live video and wireless internet may be offered as an inducement to prospective tenants to minimize idle time. If more than one camera is installed at a site, the live video streams can be displayed in a number of ways, including tiled and cascaded. Various other options are available, including viewing saved clips and controlling the size of displayed videos.

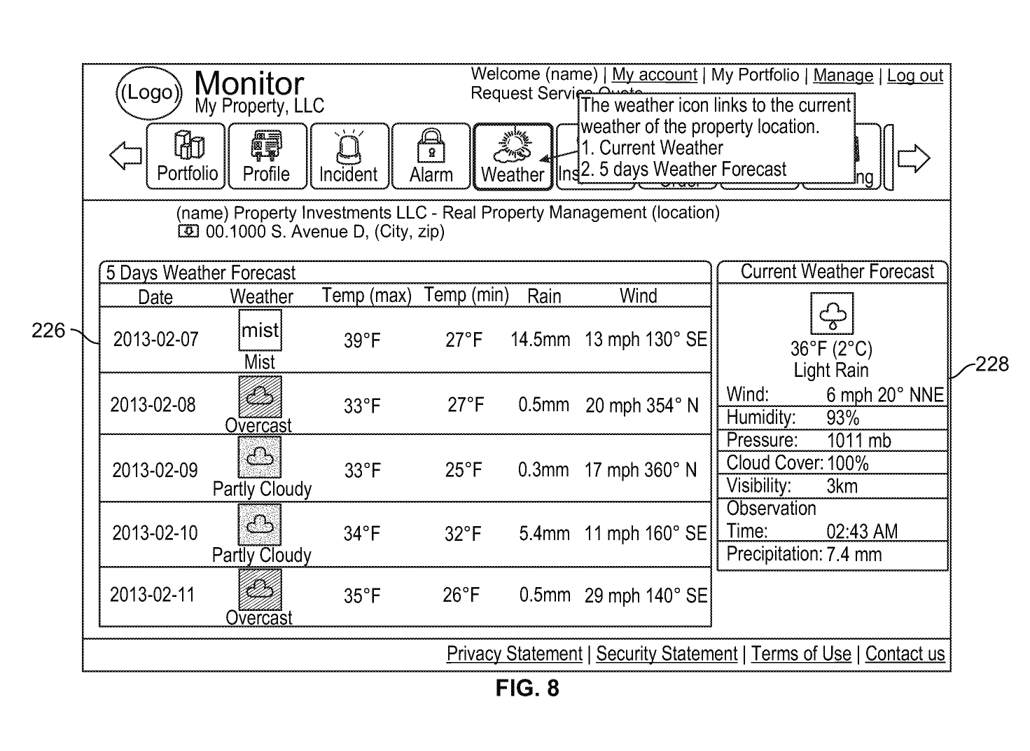

Selecting the “Alarm” tab of menu 172 results in the screen shown in FIG. 8. The header 170 and menu 172 areas are the same as those shown in FIG. 3. Panes 226 and 228 are shown for providing current and forecasted weather. Other information regarding weather can be provided as desired. The reason for the weather tab is to make it easy for remote property owners to view local weather patterns. Large Property Management firms often have international investors who own large portfolios of geographically diverse buildings and are not familiar with local weather conditions. They can use this tab to check if their property is exposed to significant weather events such as hurricanes and typhoons. The information displayed on the Alarm tab can be provided by external vendors, for example, Alarm.com.

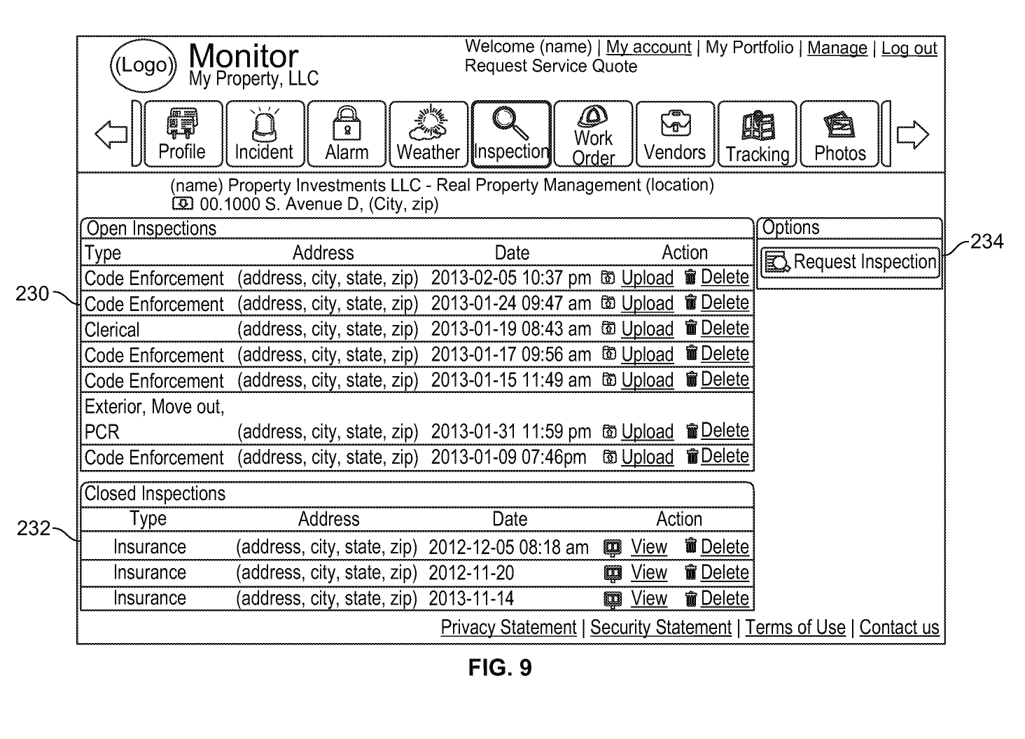

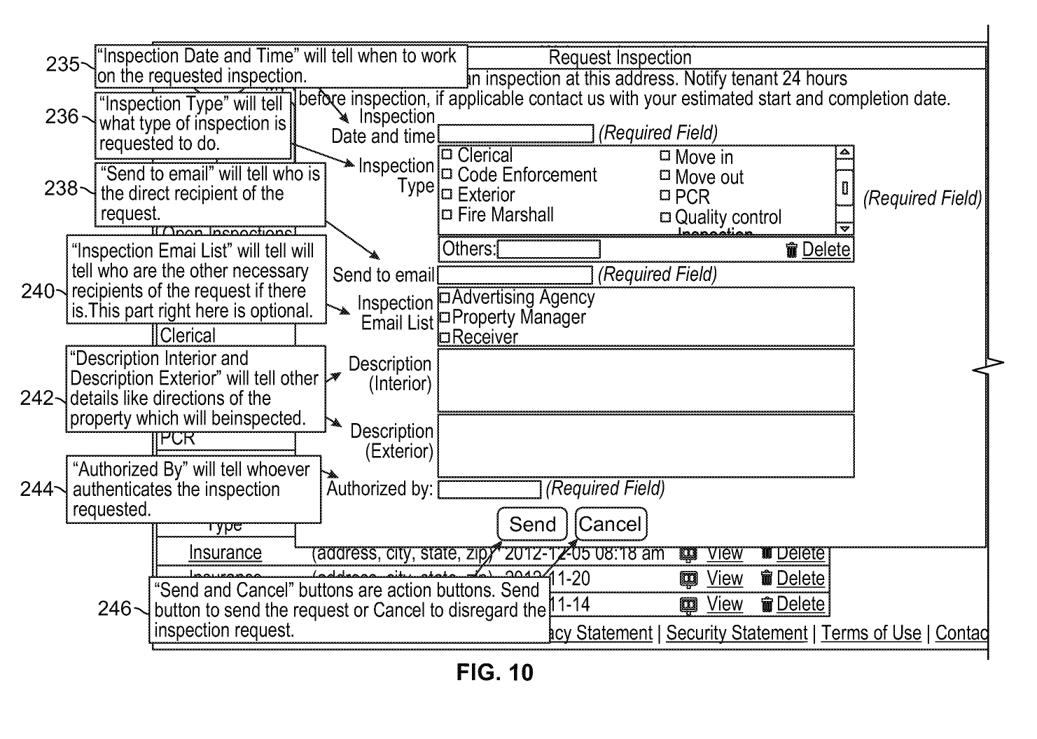

Selecting the “Inspections” tab of menu 172 results in the screen shown in FIG. 9. The header 170 and menu 172 areas are the same as those shown in FIG. 3. Panes 230 and 232 display open and closed inspections respectively. Each inspection listing can contain a variety of information, such as type, address, date and action taken. Other fields can be provided as desired. Pane 234 provides additional options for a user, such as requesting an inspection. Selecting this option will display a pop-up form similar to the report an incident form of FIG. 6 as shown in FIG. 10. In this case, the form can include, for example, field 235 for entering inspection date and time and field 236 for entering the inspection type. Inspection type can include, for example, chemical, code enforcement, exterior, fire marshal, move in, move out, PCR and quality control inspection. Fields 238 and 240 contain contact emails while fields 242 and 244 are used to provide descriptions of the interior and exterior of the property. Fields 244 and 246 are similar to fields 208 and 210 of FIG. 6.

When using the screens shown in FIGS. 9 and 10, a user, or property manager, will then complete the form to Request Inspection. The user will then set the schedule of the inspection, type of the inspection and select an inspector. In a preferred embodiment, the form will include a preset and/or default items to be inspected. These items can be then edited by the inspector upon inspection.

When completed, the inspection request form will then be sent to the Inspector's email address. The email can include details about the inspection as entered in the form and a link to accept or decline the inspection. Once confirmed, the Inspector will then be able to download the lists of buildings to be inspected sorted in dates.

The monitoring system of the invention provides the capability for the Inspector to download pictures and videos for each inspection items. Upon completing the inspection, the Inspector sends an email to Property Manager, to the tenant if there are violations and to vendors for request Work Order if repairs are needed.

Once the inspection is completed, it will then be recorded on “Closed Inspection” table where Property Manager could view the results. The information displayed on the Inspection tab can be provided by external vendors, for example, ActSoft.

In a preferred embodiment, the monitoring system of the invention may be accessed using a smart phone application. This feature is especially use for inspectors use to perform the inspections. After a user “confirms” that he or she will perform the inspection then the addresses of the open inspections are sent to the inspector's smart phone. The smart phone application then guides the inspector through the different items that need to be inspected at the building.

Although not shown in the drawings, selecting the “Inspections” tab of menu 172 results in the display of a screen similar to FIG. 9. The header 170 and menu 172 areas are the same as those shown in FIG. 3. Panes for open and closed work orders and the option to request a work order are similar to panes 230, 232 and 234 of FIG. 9. A pop-up form to request a work order is similar to the request inspection form of FIG. 10 and provides a means for a property manager to send work orders to a vendor. Many different types of work orders may be requested, including cleaning, electrical, general maintenance, HVAC repair, painting, plumbing and roof repair, etc.

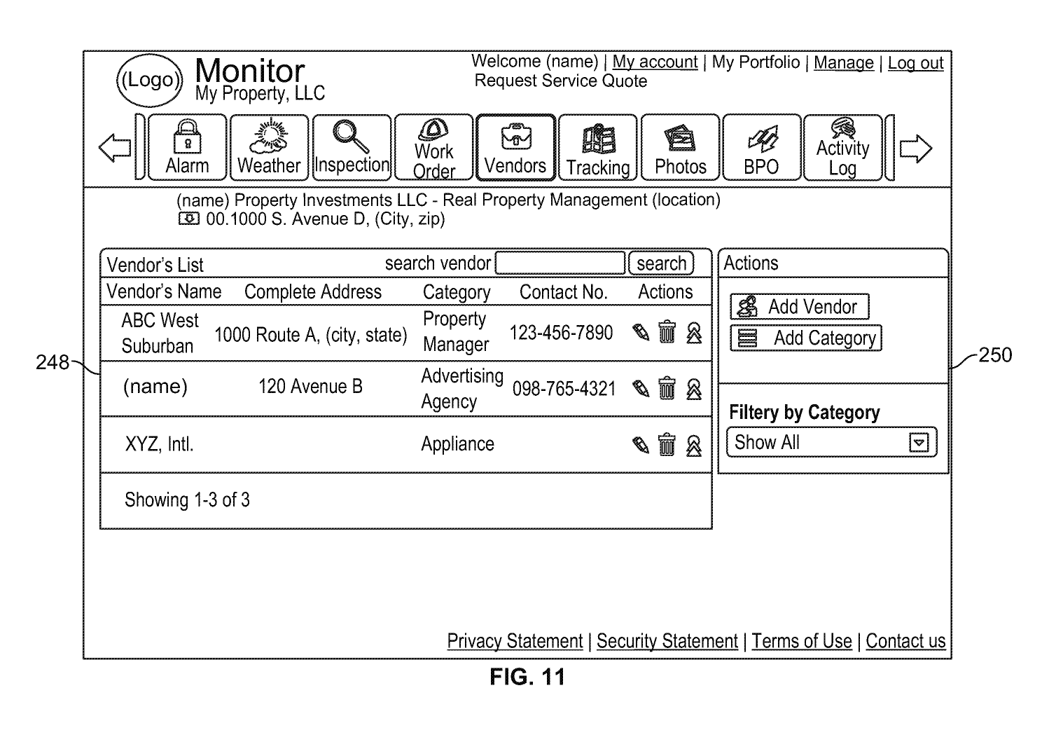

Similarly to an inspector, the vendor receives an email containing information about the work to be performed and accept and decline links. Logs are used to keep track of how often a vendor accepts and declines requests. This information may be accessed by selecting the “Vendors” tab of menu 172. This results in the screen shown in FIG. 11. The header 170 and menu 172 areas are the same as those shown in FIG. 3. Pane 248 provides a list of vendors used by the property management company. For each vendor, information such as name, address, category and contact no can be provided. Buttons for taking actions regarding specific vendors are also provided, such as editing the contact information for a vendor, deleting a vendor and setting the status of a vendor as activated or deactivated. In a preferred embodiment, pane 248 may include a search field, helpful if the list of vendors is more than one screen in length. Actions pane 250 includes options such as adding a vendor, adding a category and filtering the list of vendors by category.

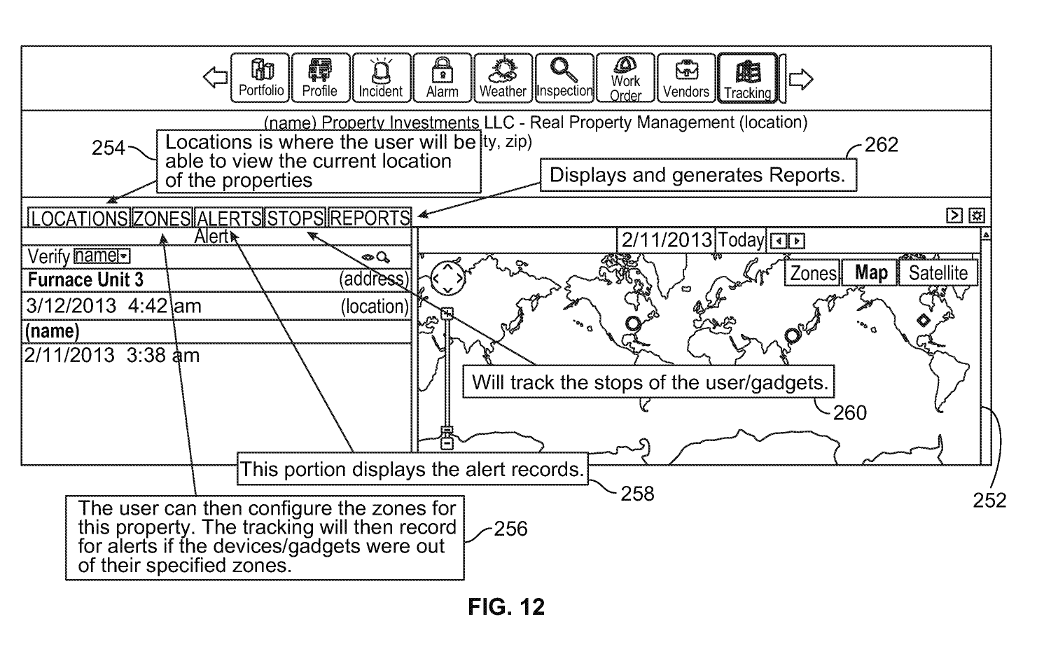

Selecting the “Tracking” tab of menu 172 results in the screen shown in FIG. 12. The header 170 and menu 172 areas are the same as those shown in FIG. 3. The tracking tab uses GPS technology to allow a user to track human and high value assets associated with a property. A user with the monitoring smart phone application can access the dashboard through the tracking tab to an employee's route and stopping intervals in real time. A vendor uses the app to check-in when arriving at a property location and check-out when leaving. Time intervals for inspection or repair are recorded through the dashboard. In a further embodiment, a GPS tracking device is attached to a high value asset such as a furnace, air conditioning unit, water heater etc. When the asset is stolen from the location an alert, for example, an event text and/or email, is sent to a system user's computer device, i.e. smart phone, tablet and/or computer. The route and location of the asset is tracked trough the dashboard allowing the user to inform authorities and retrieve the high value asset.

The tracking screen of FIG. 12 primarily includes a map area 252 for displaying locations of properties being managed and assets of those properties in response to activating locations tab 254. In the following discussion, “assets” can refer to property items such as an HVAC unit as well as employees and vendors. Zones tab 256 allows a use to configure the zone around a property. The GPS tracking will then record an alert if the tracked asset is out of the specified zone. Alert tab 258 displays alert records, Stop tab 260 allows a user to stop tracking an asset while Reports tab 262 allows a user to display and generate reports. The map display can be panned and zoomed as would be understood by one of ordinary skill in the art. The information displayed on the tracking tab can be provided by external vendors, for example, Vistracks or Numerex.

Although not shown in the drawings, selecting the “Photo Gallery” tab of menu 172 results in the display of a screen similar to FIG. 3. The header 170 and menu 172 areas are the same as those shown in FIG. 3. This tab enables a property manager to view recent and historical photos of the building. These photos may be uploaded during inspections from smart phone pictures. There are many uses for these photos and in particular they are useful for documenting the status of a building in the event of an insurance claim. Actions available on the Photo Gallery screen include uploading and deleting photos as well as adding descriptions of uploaded photos.

Although not shown in the drawings, selecting the “BPO” (Broker Price Option) tab of menu 172 results in the display of a screen similar to FIG. 9. The header 170 and menu 172 areas are the same as those shown in FIG. 3. Panes for open and closed BPOs and the option to request a BPO are similar to panes 230, 232 and 234 of FIG. 9. A pop-up form to request a BPO is similar to the request inspection form of FIG. 10. The pop-up form includes, for example, fields for entering date and time, emails of recipients, authorization and send/cancel.

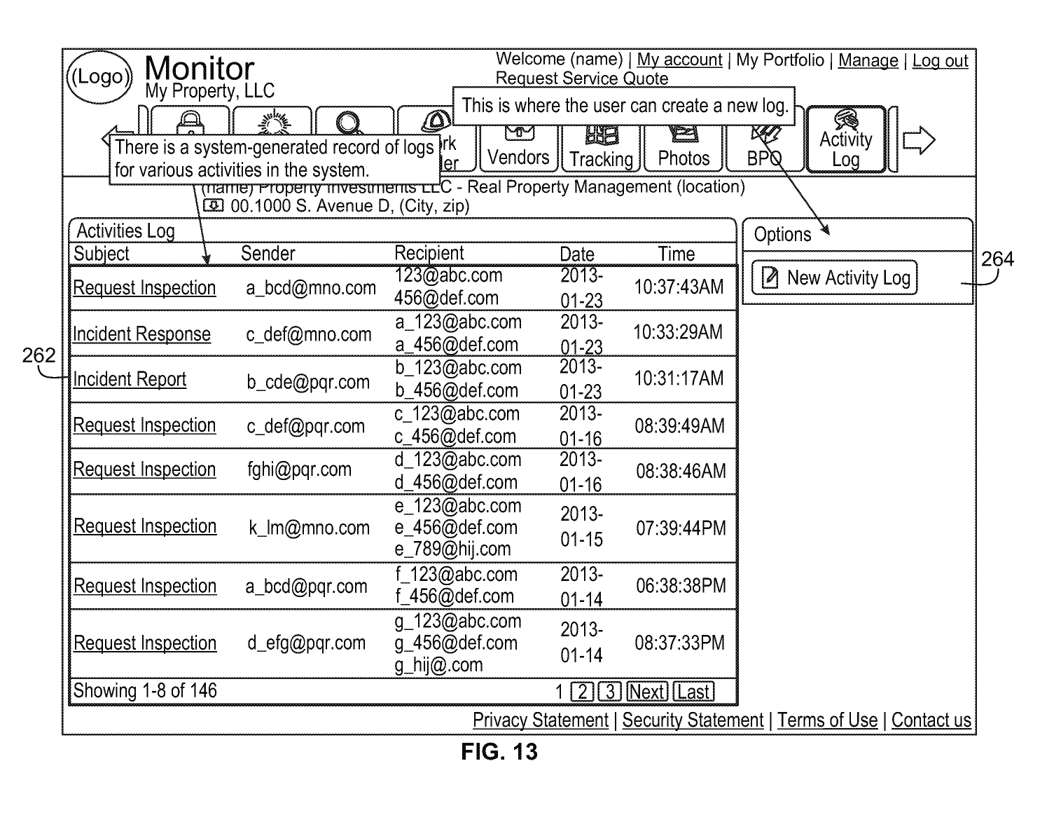

Selecting the “Activity Log” tab of menu 172 results in the screen shown in FIG. 13. The header 170 and menu 172 areas are the same as those shown in FIG. 3. The activity log, appearing in pane 262 of FIG. 13, records requests and responses of users throughout the dashboard. Users can also add comments and activities manually. The type of each activity is identified and all activities are time and date stamped. When an activity in pane 262 is clicked, it will then display the details of the activity. This could be an acceptance or denial of the inspection request, work order request and etc. Pane 264 provides an option to create a new activity log.

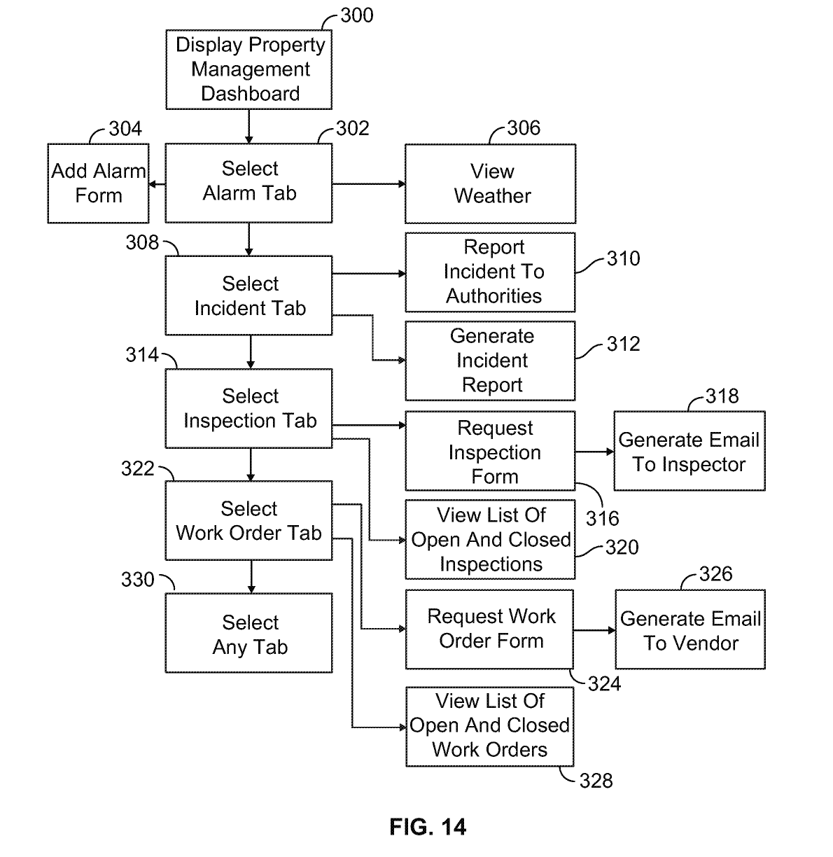

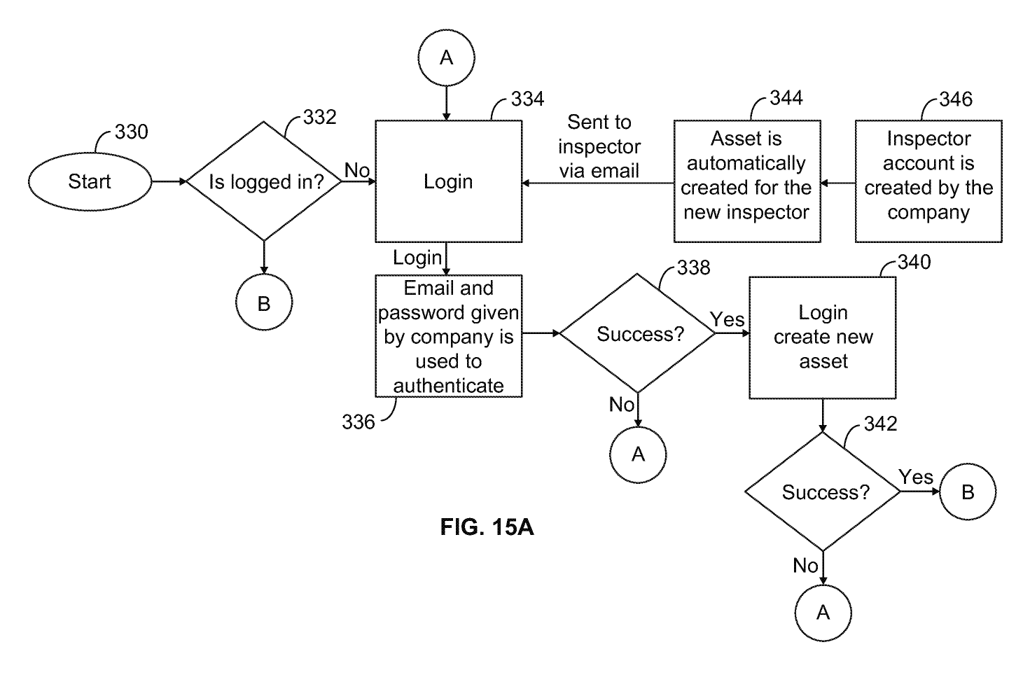

A representative operation of the invention is shown by the flowchart of FIG. 14. This flowchart depicts one possible way a user could interact with the system but there are many different ways in which this could be done. The flowchart of FIG. 14 depicts an embodiment of the invention in which all the tools needed to manage a property are integrated together so they can be used reliably.

After logging into the system, the property management dashboard of FIG. 3 is displayed to a user, for example, a property manager at 300. The user may have been notified of an alarm at a managed property and so selects the Alarm tab at 302 thus displaying the screen of FIG. 7. The user may take a number of actions as explained above, including viewing local weather 306 and adding additional alarm-generating devices to the property 304.

After reviewing alarm information, the user can then select the Incident tab at 308, displaying the screen of FIG. 5. From this screen, the user can perform a variety of actions, including sending an incident report to authorities at 310 and generating an incident report at 312.

After generating an incident report, the user may want to request investigate what may have caused the alarms by selecting the inspection tab at 314, displaying the screen of FIG. 9. From this screen, the user can fill out a request inspection form at 316 which automatically generates an email with pertinent details to a chosen inspector at 318. The user can also view a list of open and closed inspections at 320. Similarly, the user can then select the work order tab 322, fill out a work order request form 324, generate an email to a vendor 326 and view a list of open and closed work orders 328.

Finally, the user can continue to perform other property management tasks for the same property or select a new property by choosing the appropriate tab at 330.

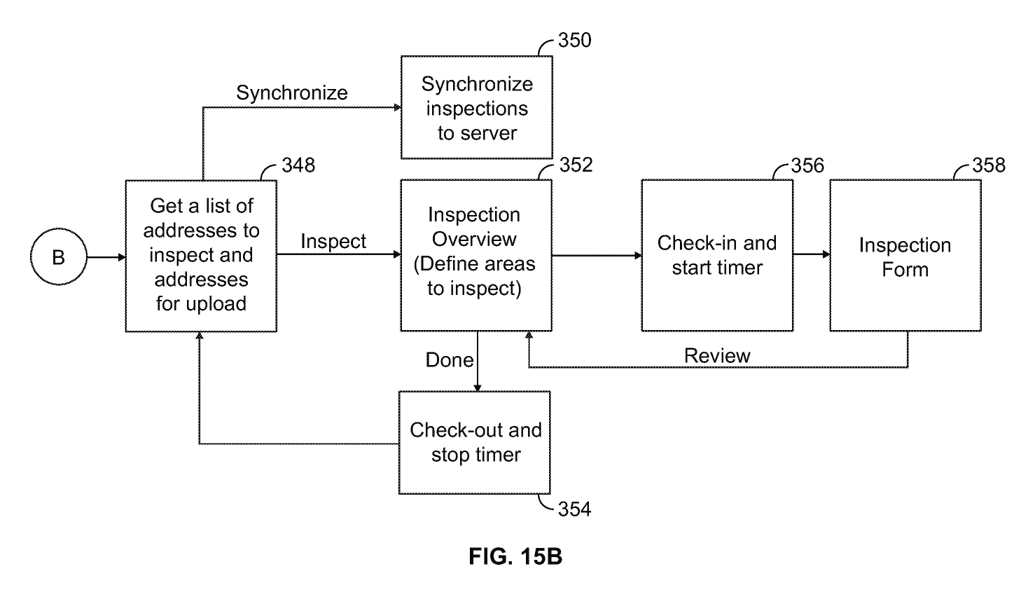

A flowchart illustrating the operation of the system during the inspection process is shown in FIGS. 15A and 15B. A process for logging into the system is shown in FIG. 15A. The process starts at 330. A check is performed to see if a user is logged in at 332. If not, the login process is initiated at 334 and an email and password is transmitted to an authentication service at 336. Prior to this process, an account has been created for the inspector at 344 and 346. If the email and password are accepted at 338, a login process is performed at 340. If successful, the process continues at connector B of FIG. 15B. If the initial login process is successful at 332, the process also continues at connector B.

Starting from connector B of FIG. 15B, after the inspector has logged in, a list of addresses to inspect is displayed to the inspector at 348. From this point, the addresses can be synchronized with server 150 of FIG. 2 at step 350. The inspector then displays an inspection overview which defines areas to inspect for each address at 352. The inspector travels to the address, checks in using a portable computing device such as a smart phone or tablet at 356. A timer is also started in step 356. The inspector then completes an inspection form at 358. When finished inspecting and reviewing the form, the inspector uploads the form, checks out and stops the timer at 354. At this point, the process returns to step 348 where the inspector can select the next address to inspect from the list.

Numerous alternative implementations of the present invention exist. In the preferred embodiment some of the property management services, for example, alarm tab and the tracking tab, are provided by companies and integrated into the inventive system. The specific sensing and monitoring devices in the building can be chosen from a wide variety of commercially available devices.

The apparatus of FIG. 1 in one example comprises a plurality of components such as one or more of electronic components, hardware components, and computer software components. A number of such components can be combined or divided in the apparatus. An example component of the apparatus employs and/or comprises a set and/or series of computer instructions written in or implemented with any of a number of programming languages, as will be appreciated by those skilled in the art.

The apparatus of FIG. 1 in one example employs one or more computer-readable signal-bearing media. The computer-readable signal-bearing media store software, firmware and/or assembly language for performing one or more portions of one or more implementations of the invention. The computer-readable signal-bearing medium for the apparatus 100 in one example comprise one or more of a magnetic, electrical, optical, biological, and atomic data storage medium. For example, the computer-readable signal-bearing medium comprises floppy disks, magnetic tapes, CD-ROMs, DVD-ROMs, hard disk drives, and electronic memory.

The steps or operations described herein are just for example. There may be many variations to these steps or operations without departing from the spirit of the invention. For instance, the steps may be performed in a differing order, or steps may be added, deleted, or modified.

Although example implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

What is claimed is:

1. A business method for managing property comprising the steps of:
creating a database of information about one or more properties to be managed, said database operatively coupled to a server and both said server and said database operatively coupled to at least one network;
using a web-based interface to said server to access property information in said database over a network; and
using the web-based interface to said server to perform property management tasks.

2. The business method of claim 1 wherein the property to be managed is real estate property.

3. The business method of claim 1 wherein the step of using the web-based interface to said server to perform property management tasks further comprises the step of:
reporting incidents at the property including at least one of vandalism, theft or natural disasters.

4. The business method of claim 1 wherein the step of using the web-based interface to said server to perform property management tasks further comprises the step of:
installing one or more sensors at the property; and
receiving an alarm when one or more of the sensors detects a condition outside of standard norms.

5. The business method of claim 1 wherein the step of using the web-based interface to said server to perform property management tasks further comprises the step of:
selecting a property requiring inspection;
selecting a inspector to perform the inspection;
using the web-based interface to send a request to the inspector with information about the property to be inspected and the type of inspection required; and
using the web-based interface to generate a list of open and closed inspections.

6. The business method of claim 5 wherein the step of using the web-based interface to said server to perform property management tasks further comprises the step of:
selecting a property requiring repair or other work;
selecting a vendor to perform the repair or other work;
using the web-based interface to send a work order to the vendor with information about the property to be inspected and the type of repair or work required; and
using the web-based interface to generate a list of open and closed work orders.

7. The business method of claim 6 wherein the step of using the web-based interface to said server to perform property management tasks further comprises the step of:
using the web-based interface to access and update a list of vendors approved to perform inspections and repair or other work on properties being managed.

8. The business method of claim 1 wherein the step of using the web-based interface to said server to perform property management tasks further comprises the step of:
entering a global positioning system (GPS) identifier for one or more assets associated with the properties;
receiving real-time information about the GPS coordinates of the one or more assets over the one or more networks and storing the information in the database;
graphically displaying the position of the asset on a map in real-time; and
accessing additional information about the asset using the web-based interface.

9. The business method of claim 1 wherein the step of using the web-based interface to said server to perform property management tasks further comprises the step of:
viewing real-time video feeds from cameras installed at the property; and
uploading and viewing images of the property.

10. The business method of claim 1 wherein the step of using the web-based interface to said server to perform property management tasks further comprises the step of:
selecting a property requiring an appraisal or broker price opinion (BPO);
selecting a vendor to perform the appraisal or BPO;
using the web-based interface to send a request to the vendor with information about the property needing an appraisal or BPO; and
using the web-based interface to generate a list of open and closed appraisals and BPOs.

11. The business method of claim 1 wherein the web-based interface is accessed using a computing device comprising any of a smart phone, a laptop, a desktop computer or a tablet.

12. A business method for monitoring vacant property comprising the steps of:
creating a database of information concerning one or more properties to be managed, said database operatively coupled to a server and both said server and said database operatively coupled to at least one network;
using a web-based interface to access said server, over said network, to access a plurality of property information in said database and to perform property management tasks;
using the web-based interface to access said server to perform property management tasks;
installing one or more sensors in the one or more properties for monitoring the properties;
receiving, by the server, real-time information from the one or more sensors; and
generating incident reports and alerts to persons responsible for the properties when one or more sensors detect a condition outside of defined norms.

13. The business method of claim 1 wherein the step of using the web-based interface to said server to perform property management tasks further comprises the step of:
selecting a property requiring inspection;
selecting a inspector to perform the inspection; and
using the web-based interface to send a request to the inspector with information about the property to be inspected and the type of inspection required; and
using the web-based interface to generate a list of open and closed inspections.

14. The business method of claim 13 wherein the step of using the web-based interface to said server to perform property management tasks further comprises the step of:
selecting a property requiring repair or other work;
selecting a vendor to perform the repair or other work;
using the web-based interface to send a work order to the vendor with information about the property to be inspected and the type of repair or work required; and
using the web-based interface to generate a list of open and closed work orders.

15. The business method of claim 14 wherein the step of using the web-based interface to said server to perform property management tasks further comprises the step of:
using the web-based interface to access and update a list of vendors approved to perform inspections and repair or other work on properties being managed.

16. The business method of claim 12 wherein the step of using the web-based interface to said server to perform property management tasks further comprises the step of:
entering a global positioning system (GPS) identifier for one or more assets associated with the properties;
receiving real-time information about the GPS coordinates of the one or more assets over the one or more networks and storing the information in the database;
graphically displaying the position of the asset on a map in real-time; and
accessing additional information about the asset using the web-based interface.

17. The business method of claim 12 wherein the step of using the web-based interface to said server to perform property management tasks further comprises the step of:
viewing real-time video feeds from cameras installed at the property; and
uploading and viewing images of the property.

18. The business method of claim 12 wherein the web-based interface is accessed using a computing device comprising any of a smart phone, a laptop, a desktop computer or a tablet.

19. A system for remotely monitoring property comprising:
a web server operatively coupled to one or more networks;
a database for storing information about one or more properties being monitored, said database operatively coupled to the server and the one or more networks;
a computing device for using a web-based interface to access the web server and update the database over the one or more networks; and
one or more sensors installed in a property to be monitored and operatively coupled to the network, said one or more sensors sending real-time alerts to said web server when the one or more sensors detects a condition outside standard norms.

20. The system of claim 16 wherein the computing device comprises any of a smart phone, a laptop, a desktop computer or a tablet device.
